(19) United States
(12) Patent Application Publication
(10) Pub. No.: US 2009/0284033 A1
(43) Pub. Date: Nov. 19, 2009

(54) PROCESS FOR PRODUCTION OF AN EQUIPMENT PART FOR A MOTOR VEHICLE, MOULD AND EQUIPMENT PART

(75) Inventor: Hubert Bruckner, Erkrath (DE)

Correspondence Address: FOLEY AND LARDNER LLP;SUITE 500, 3000 K STREET NW, WASHINGTON, DC, 20007, US

(73) Assignee: JOHNSON CONTROLS INTERIORS GMBH & CO. KG, Grefrath (DE)

(21) Appl. No.: 12/306,318

(22) PCT Filed: Jun. 22, 2007
(86) PCT No.: PCT/EP2007/005529

§ 371 Date: May 18, 2009

(30) Foreign Application Priority Data
Jun. 29, 2006 (DE) 10 2006 030 440.3

(51) Int. Cl. B29C 45/14; B60R 13/00

(52) U.S. Cl. 296/1.07; 264/274; 425/542

(57) ABSTRACT

A process is proposed for production of an equipment part having on its physical side at least one first surface zone and one second surface zone, for a motor vehicle, in particular an interior-equipment part, where the first surface zone is formed by means of an insert part, where a mould is used for production of the second surface zone of the equipment part and where, in the region of transition between the first surface zone and the second surface zone, the mould is sealed off with respect to the insert part.

The present invention relates to a process for production of an equipment part, having on its visible side at least one first surface zone and one second surface zone, for a motor vehicle, in particular an interior-equipment part.

A process of this type for production of an equipment part is generally known. For example, German patent specification DE 39 11 485 C1 discloses a process for production of one-piece, thin-walled, flexible, plastic material bodies, which are made of reaction resins and structured on their visible side into two or more zones, for the surface configuration of equipment parts for motor vehicles. However, a drawback of this process is the fact that the delimitation of the surface zones to be differently configured is difficult and possible merely in an imprecise manner, so that allowance may not be made for the visual requirements placed on the motor vehicle equipment part.

The object of the present invention is to provide a process for production of an equipment part, having on its visible side at least one first surface zone and one second surface zone, for a motor vehicle, in particular an interior-equipment part, which process allows precise delimitation between various surface zones and on the one hand permits this delimitation with the necessary visual quality and on the other hand provides a simple, robust production process which is inexpensive to carry out.

This object is achieved by a process for production of an equipment part, having on its visible side at least one first surface zone and one second surface zone, for a motor vehicle, in particular an interior-equipment part, wherein the first surface zone is formed by means of an insert part, wherein a mold is used for production of the second surface zone of the equipment part, wherein the mold is sealed off, in the region of the transition between the first surface zone and the second surface zone, with respect to the insert part. As a result, according to the invention, on the one hand it is advantageously possible to allow precise and distinct delimitation of the surface zones of the equipment part and, on the other hand, as a result according to the invention it is also possible to use any desired materials of the insert part, for example an insert part which is made of leather and has a high-quality visual appearance or the like. Furthermore, according to the invention it is particularly advantageously also possible to avoid complex molds as a result of the fact that, in a first step, the insert part is molded and, in a second step, the insert part is inserted into the mold and the second surface zone is formed by means of an injection molding process. As a result, according to the invention it is advantageously possible to avoid undercut regions which result in complex molds. Although this case requires a greater number of molds, namely in addition to the mold for forming the second surface zone a further mold also for forming or molding the insert part, both of these molds display less complexity than would be required to form undercut regions in a single mold.

According to the invention, provision is preferably made for the second surface zone to be formed, when the insert part is inserted into the mold, by injecting a material forming the second surface zone in an injection molding process. According to the invention, this particularly advantageously allows an especially stable connection to be attained between the first and second surface zones of the interior-equipment part or the equipment part, so that the stability of the equipment part is significantly improved.

According to the invention, it is furthermore preferable for the insert part to have an edge region, wherein the insert part is surrounded, in the edge region at least on its front which faces the visible side or at least on its back which is remote from the visible side, by the material forming the second surface zone, or for the insert part to be surrounded, in the edge region on its front and on its back, by the material forming the second surface zone. As a result, on the one hand, a broad range of variants can be configured with regard to the region of transition between the first surface zone and the second surface zone and furthermore, according to the invention, it is particularly advantageously possible for the connection between the various surface zones to be configured in an especially durable and stable manner.

Furthermore, according to the invention it is preferable for the sealing, in the region of the transition between the first surface zone and the second surface zone, with respect to the insert part, to take place by means of a flexible seal and an application of pressure medium or for the sealing to take place by means of a rigid seal. As a result, according to the invention it is possible to attain a broad range of variants with regard to the sealing between the two surface regions within the mold, so that the process according to the invention for production of the equipment part can be adapted for example to the respective material of the insert part or to the respective material combination consisting of insert parts and material of the second surface zone.

The present invention further relates to a mold for production of an equipment part, having at least one first surface zone and one second surface zone, for a motor vehicle, in particular an interior-equipment part, wherein the mold has a mold zone corresponding to the second surface zone and a seal with respect to the first surface zone.

According to the invention, this particularly advantageously provides an inexpensive embodiment for carrying out the method according to the invention. In particular, the mold according to the invention can display, despite a high degree of complexity—for example with regard to the cuts or the like—of the equipment part, comparatively low complexity.

It is preferable for the seal to be flexible and preferably to have an application of pressure medium or for the seal to be rigid. This allows the mold to be adapted in a simple manner to differing conditions of the equipment part to be produced.

The present invention further relates to an equipment part for a motor vehicle, in particular an interior-equipment part and in particular produced using the process according to the invention, wherein the equipment part has a first surface zone and a second surface zone and a material forming the second surface zone is provided in an edge region of a feeder so as to surround said feeder at least on one side. This allows the equipment part according to the invention to be produced particularly simply, inexpensively and rapidly at a predefined molding complexity, for example with regard to an undercut.

Exemplary embodiments of the present invention are illustrated in the drawings and will be described in greater detail in the subsequent description. In the drawings:

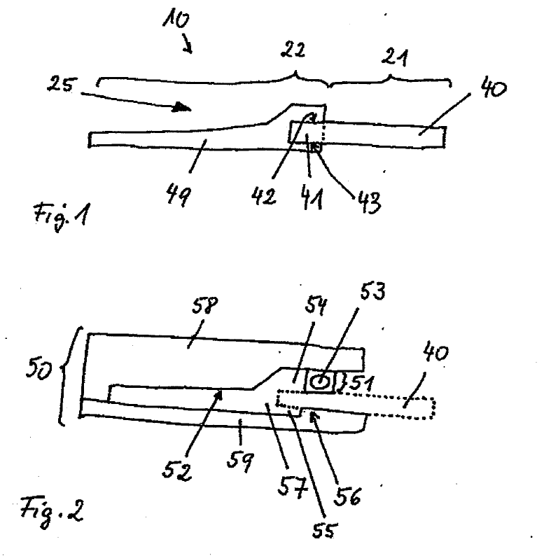

FIG. 1 is a cross section through an equipment part according to the invention with a first surface zone and a second surface zone; and

FIG. 2 is a schematic sectional view of a mold for production of an equipment part according to the invention or for carrying out a process according to the invention.

FIG. 1 is a cross section through an equipment part 10 according to the invention with a first surface zone 21 and a second surface zone 22 on a visible side 25 of the equipment part 10. The equipment part 10 has an insert part 40 and a material 49 which forms the second surface zone 22 and is molded by means of an injection molding process. In an edge region 41 of the insert part 40, said insert part is surrounded on a front 42 and on a back 43 by the material 49 forming the second surface zone 22. This forms a good and stable connection between the insert part 40 and the material 49 forming the second surface zone 22. Alternatively thereto, provision may also be made (in a manner not shown) for merely the back 43 or merely the front 42 of the edge region 41 to be included at the connecting point between the insert part 40 and the material 49 forming the second surface zone 22, for example for a different visual configuration of the transition from the first surface zone 21 to the second surface zone 22.

FIG. 2 is a schematic sectional view of a mold 50 for production of an equipment part 10 according to the invention or for carrying out a process according to the invention. The mold 50 comprises in this case generally a first part 58 and a second part 59, for example as an upper part or lower part. In order to form the equipment part 10, firstly the insert part 40 is now inserted in a first process step into the mold 50 and locked. According to the invention, this is brought about in particular by means of clamping of the insert part 40 between the first and second part 58, 59 of the mold 50. For this purpose, FIG. 2 shows the insert part 40 (in a dotted line) inserted or clamped between the two parts 58, 59 of the mold 50.

In order to form the two surface zones 21, 22 on the visible side 25 of the equipment part 10, the mold 50 has a seal 51 which prevents part of the material 49 forming the second surface zone 22 from entering, during the phase of the molding of this material 49 (i.e. provided that this material is still liquid or deformable), the first surface zone 21, i.e. from reaching the visible side of the insert part 40. In order to clamp the insert part 40, the mold 50 also has in a particularly preferred embodiment a clamping element 56, which ensures in conjunction with the seal 51 that, on the one hand, the insert part 40 is properly secured or locked and that on the other hand, for production of the material 49, i.e. of the second region of the equipment part 10, a closed and sealed volume 57 is formed within the closed mold 50. According to the invention, this volume 57 within the closed mold 50 can in this case comprise, for connecting the insert part 40 to the second region of the equipment part 10, alternatively or cumulatively a region 54 for forming a front enclosure of the edge region 41 of the insert part 40 and/or a region 55 for forming a rear enclosure of the edge region 41 of the insert part 40.

It is particularly preferable for the seal 51 to be a flexible or a hard or a rigid seal 51. A flexible seal 51 is preferable when the insert part 40 is a sensitive part. A hard or rigid seal 51 is preferable if the requirements placed on tightness during the carrying-out of the injection molding process for forming the material 49 are particularly stringent. In a particularly preferred embodiment of the invention, provision is made for the seal 51 to be embodied as a seal to which a pressure medium is applied, i.e. for example for the seal 51 to be formed in a tubular manner and to have applied to it a pressure medium—for example compressed air or else a pressurized liquid—in a cavity 53 of the seal 51 (for the sake of simplicity, the application of the pressure medium is not shown). In this case, the sealing of the volume 57 can be brought about in a particularly effective manner without exerting excessively high pressure or without exerting excessively high forces based on a specific surface of the insert part 40 or the edge region 41 thereof. According to the invention, this also allows the insert part 40 to be treated in a particularly gentle manner on its visible side 25, so that the transition from the first surface region 21 to the second surface region 22 can be configured in a particularly visually or aesthetically attractive manner.

1. A process for production of an equipment part, having on its visible side at least one first surface zone and one second surface zone, for a motor vehicle, in particular an interior-equipment part, wherein the first surface zone is formed by means of an insert part, wherein a mold is used for production of the second surface zone of the equipment part, wherein the mold is sealed off, in the region of the transition between the first surface zone and the second surface zone, with respect to the insert part.

2. The process as claimed in claim 1, wherein the second surface zone is formed, when the insert part is inserted into the mold, by injecting a material forming the second surface zone in an injection molding process.

3. The process as claimed in claim 2, wherein the insert part has an edge region, wherein the insert part is surrounded, in the edge region at least on its front which faces the visible side or at least on its back which is remote from the visible side, by the material forming the second surface zone.

4. The process as claimed in claim 3, wherein the insert part is surrounded, in the edge region on its front and on its back, by the material forming the second surface zone.

5. The process as claimed in claim 1, wherein the sealing, in the region of the transition between the first surface zone and the second surface zone, with respect to the insert part, takes place by means of a flexible seal and an application of pressure medium.

6. The process as claimed in claim 1, wherein the sealing, in the region of the transition between the first surface zone and the second surface zone, with respect to the insert part, takes place by means of a rigid seal.

7. A mold for production of an equipment part, having at least one first surface zone and one second surface zone, for a motor vehicle, in particular an interior-equipment part, wherein the mold has a mold zone corresponding to the second surface zone and a seal with respect to the first surface zone.

8. The mold as claimed in claim 7, wherein the seal is flexible and preferably has an application of pressure medium.

9. The mold as claimed in claim 7, wherein the seal is rigid.

10. An equipment part for a motor vehicle, in particular an interior-equipment part and in particular produced using a process as claimed in claim 1, wherein the equipment part has a first surface zone and a second surface zone, characterized in that a material forming the second surface zone is provided in an edge region of a feeder so as to surround said feeder at least on one side.
